(19) United States
(12) Patent Application Publication
(10) Pub. No.: US 2009/0061408 A1
(43) Pub. Date: Mar. 5, 2009

(54) DEVICE AND METHOD FOR EVALUATING LEARNING

(75) Inventors: Ming Hsiang Yen, Jung-He City (TW); Jui Yu Yen, Jung-He City (TW); Kuang Chien Kao, Jung-He City (TW)

Correspondence Address: APEX JURIS, PLLC, 12733 LAKE CITY WAY NORTHEAST, SEATTLE, WA, 98125, US

(73) Assignee: MICRO-STAR INT'L CO., LTD., Jung-He City (TW)

(21) Appl. No.: 12/186,267

(22) Filed: Aug. 5, 2008

Related U.S. Application Data
(60) Provisional application No. 60/968,353, filed on Aug. 28, 2007.

(51) Int. Cl. G09B 7/06

(52) U.S. Cl. 434/353

(57) ABSTRACT

A device and method for evaluating learning including a level examining module, a course planning module and a course evaluation module are provided. The level examining module provides a level examination for a user to determine a current capability level of the user. The course planning module plans a learning course for the use according to the current capability level as determined by the level examining module. The course evaluation module generates an evaluation quiz according to the learning course. After the user finishes the evaluation quiz, the course evaluation module also generates learning information to evaluate the user's learning status.

### CROSS-REFERENCES TO RELATED APPLICATIONS

This application is a non-provisional application of the U.S. provisional application Ser. No. 60/968,353, entitled “Interactive Learning System” filed on Aug. 28, 2007.

### FIELD OF INVENTION

The present invention relates to a learning device and method, and more particularly to a device and method for evaluating learning.

### BACKGROUND

As science and technology progresses day by day, modern people need to learn new knowledge which is being generated continuously. To cater to the modern person's busy lifestyle, there are many portable devices available in the market equipped with learning functions, thereby allow people to take advantage of any leisure time to learn knowledge. For example, the language learning device that people use most frequently is an electronic dictionary. Apart from looking up vocabulary, currently available electronic dictionaries also provide a restudy function to help users review repeatedly certain Chinese or English words after looking them up. This helps the user become familiar with this vocabulary and memorize them. In addition to this learning function, some devices include a test function to allow the user to grade themselves with a post quiz.

A relevant TW patent is “Portable Learning Device for Language Vocabulary”, Application No. 82,207,657. In this patent application, a learning device for language vocabulary is disclosed to display repeatedly vocabulary on a screen, so as to increase the opportunity for learning and memorizing the vocabulary. Since the vocabulary stored in the learning device is specific, the user can easily use it without complex input through the keyboard. To test the user's learning progress, a simple button is provided to enter a test stage; and the display probability of said vocabulary in the next stage is reduced according to the test result. Therefore, the probability of learned vocabulary being displayed again will fall, and un-memorized vocabulary have a greater opportunity for display.

Another relevant TW patent is “Restudy system and Method for Vocabulary Selecting with Multimedia Aids”, Application No. 92,107,412. This patent application is used on an electronic dictionary. When the user is performing the vocabulary learning function, a list of vocabulary will be generated according to a weighted ranking of a learning evaluation result. When the vocabulary selection-restudy function is selected, the electronic dictionary will acquire and display one word in the list of learning vocabulary, as well as multimedia information (such as voices, pictures, animations) corresponding to the word. The user's memory of the word will thus be strengthened to achieve the objective of vocabulary selection and restudy.

However, conventional technology and the relevant patents mentioned above still have the following problems:

(1) In conventional technology, when the user is using learning functions, no level-analysis is applied to the user to discern an appropriate learning course according to the user's current capability level.

(2) The test results of a post-quiz after a learning course are usually insufficiently precise for the user to understand their current memorization capacity, learning progress, learning rate for each question (vocabulary), etc.

(3) After the post-quiz, those questions that have lower learning rates cannot be stored for the user to include next time, for restudy and enhancement of learning rate.

Therefore, the solution of the problems of the aforesaid learning device and enhancement of the user's learning efficiency is a critical issue as yet unreached.

### SUMMARY OF THE INVENTION

To solve the aforesaid technical problems in the prior art, the present invention provides a device and method for evaluating learning. Initially, the user's level will be determined first to choose an appropriate learning course. During or after the learning course, the user may proceed with evaluating learning, thereby generating detailed learning information and making the user aware of their current learning status.

In an embodiment according to the present invention, a device for evaluating learning includes a level examining module, a course planning module and a course evaluation module. The level examining module provides a level examination for a user to determine their current capability level. The course planning module plans a learning course for the user according to the current capability level, as determined by the level examining module. The course evaluation module generates an evaluation quiz according to the learning course. And after the user finishes the evaluation quiz, the course evaluation module also generates learning information to evaluate the user's learning status.

In another embodiment according to the present invention, a method for evaluating learning includes the following steps. First, providing a level examination for a user to determine the user's current capability level. Second, planning a learning course for the user according to their current capability level. Third, generating an evaluation quiz according to the learning course, and generating learning information after the user finishes the evaluation quiz which assesses the user's learning status.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The present invention can be more fully understood by reference to the following description and accompanying drawings, in which:

FIG. 1 is an explanatory block diagram of a device for evaluating learning according to a first preferred embodiment of the present invention;

FIG. 2 is an explanatory block diagram of another device for evaluating learning according to a second preferred embodiment of the present invention;

FIG. 3 is a first explanatory diagram of the learning rate according to the present invention;

FIG. 4 is a second explanatory diagram of the learning rate according to the present invention;

FIG. 5 is an explanatory diagram of the learning curve according to the present invention; and

FIG. 6 is an explanatory flow chart of a method for evaluating learning according to a preferred embodiment of the present invention.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description refers to the same or the like parts.

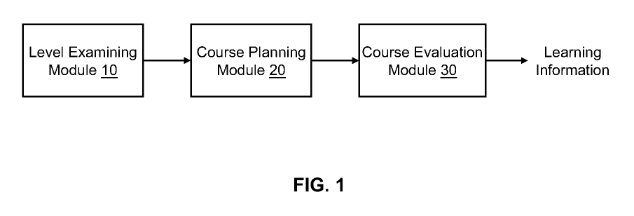

Please refer to FIG. 1, which illustrates an explanatory block diagram of a device for evaluating learning according to a first preferred embodiment of the present invention. The device for evaluating learning disclosed in the present embodiment mainly includes a level examining module 10, a course planning module 20 and a course evaluation module 30.

The device for evaluating learning basically provides a user with a learning course. Through some evaluation quizzes corresponding to the learning course, and through the user's answer(s) to the evaluation quizzes, the device for evaluating learning will assess the user's current learning status and display learning information to the user. Before any learning course is provided, the level examining module 10 is used to provide level examination for the user to determine the user's current capability level. Thus, the device for evaluating learning is able to provide learning course(s) appropriate to the user's current capability level. Consequently, the results from the corresponding evaluation quiz of the appropriate learning course will be more representative of the user's actual learning status.

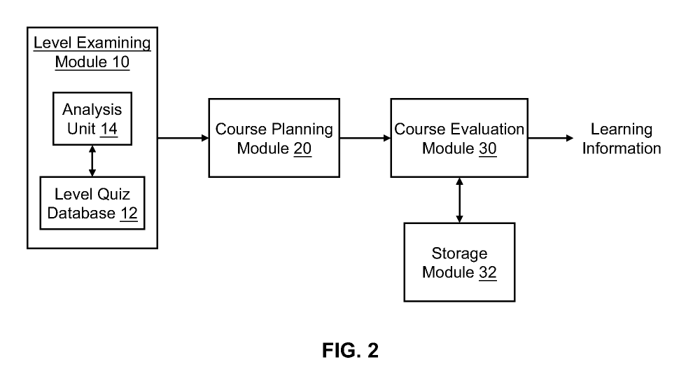

Please refer to FIG. 2, which illustrates an explanatory block diagram of another device for evaluating learning according to a second preferred embodiment of the present invention; wherein the level examining module 10 includes a level quiz database 12 and an analysis unit 14.

To examine the user's current capability level, multiple level quizzes corresponding to multiple capability levels are stored in the level quiz database 12. For example, from Elementary School Third Grade to University Fourth Grade, every grade may be considered as a single capability level. Thus there are total fourteen capability levels from Elementary School Third Grade to University Fourth Grade. Such an example is only for the purposes of explanation and should not be understood as any limitation to the present invention.

The analysis unit 14 acquires a specific level quiz from the level quiz database according to an initial level to examine the user; wherein the initial level may be a system default or determined by the user. A method for examining the user's current capability level according to the present invention, is that the analysis unit 14 first acquires a level quiz corresponding to the initial level, and then if the user answers the level quiz “correctly”, the analysis unit 14 increases the level grade and acquires another one level quiz higher than the current capability level to reexamine the user; if the user answers the level quiz “incorrectly”, the analysis unit decreases the level grade and acquires another one of the level quizzes lower than the current one of the capability levels to reexamine the user. The steps disclosed above will be repeated until the level grade reaches a threshold grade. When the user answers the level quizzes continuously and finally the user's accumulated level grade reaches the threshold grade, the user will be recognized at the current capability level. Furthermore, during examining the user's current capability level, if the user abandons the level quiz, the level grade will not be changed; it remains the same. Another level quiz with a lower capability level will be acquired to reexamine the user.

When the user's current capability level is determined by the level examining module 10, the course planning module 20 will plan a learning course for the user according to the user's current capability level determined by the level examining module 10; wherein the learning course may involve different types of knowledge or information to fulfill every user's need, such as learning courses of multi-country languages, multi-country histories, multi-country geography, math and etc.

The course evaluation module 30 generates a corresponding evaluation quiz according to the learning course planned by the course planning module 20; thus the evaluation quiz will be changed according to different learning courses. In addition, the evaluation quizzes generated by the course evaluation module 30 may be downloaded from an external computer. It is possible that different evaluation quizzes may be downloaded even though they correspond to the same learning course. Therefore, different evaluation quizzes may be downloaded from the computer and provided for the user to practice with, even though the user intends to download the evaluation quiz through the same learning course. Moreover, multiple users may download different evaluation quizzes through the same learning course, and do the test at the same time, similar to general formal examinations.

The evaluation quiz may be provided to the user at any time during or after the learning course. After the user finishes the evaluation quiz, learning information is generated to evaluate the user's learning status. In contrast with the prior art, the problem of failing to provide the user with the learning status during the learning course, is resolved by the present invention. In other words, the present invention facilitates the user's awareness of the current learning status at any time during the learning course.

When the user finishes the evaluation quiz, the learning information generated by the course evaluation module 30 may include various data or information to help the user understand their current learning status through the learning information. For example, the learning information may include examination results. After being tested by the evaluation quiz, an examination result may be generated for the user to easily understand their current learning status. It is comparable to a general examination. When the examinee receives a grade report, the learning status of the examined subject is substantially indicated on the grade report.

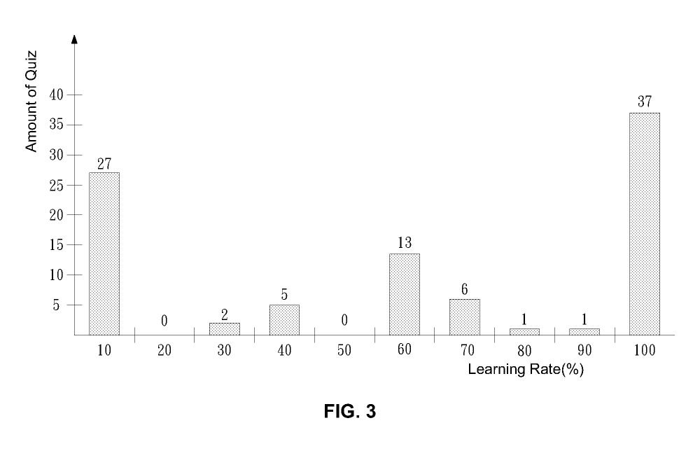

Please refer to FIG. 3, which illustrates a first explanatory diagram of learning rate according to the present invention. The learning information may further include multiple learning rates. All the evaluation quizzes finished by the user provide gathered statistics and are assigned to a corresponding learning rate. FIG. 3 shows the learning rate is divided into ten learning rate intervals (0˜10%, 11˜20% . . . 91˜100%), which should not be understood as a limitation of the present invention. When the user finishes the evaluation quizzes, each of the evaluation quizzes is assigned to a corresponding learning rate according to the examination result of each of the evaluation quizzes. In every learning rate interval shown in FIG. 3, every vertical bar indicates a corresponding learning rate involved in the learning rate interval. Each of the bars indicates the accumulated amount of the evaluation quizzes with their learning rates involved in as learning rate interval. Evaluation quizzes with higher learning rates indicate the user has achieved better learning success (such as more vocabulary memorized) on the evaluation quizzes. Evaluation quizzes with lower learning rates indicate the user has achieved worse learning success (such as less vocabulary memorized) on the evaluation quizzes.

Please refer to FIG. 2 again. The device for evaluating learning includes a storage module 32 for those evaluation quizzes on which the user scores lower than a certain learning rate. When the user finishes the evaluation quiz and the learning rate is generated, the storage module 32 stores evaluation quizzes for which the user scored a lower learning rate. The user needs to practice more on those evaluation since the low score indicates the user has experienced lower learning success (such as less vocabulary memorized). The storage module 32 may therefore be used to store evaluation quizzes if their corresponding learning rate is lower than a predefined learning rate. These evaluation quizzes may subsequently be acquired from the storage module 32 and provided to the user for more practices. Thus, the learning rate of evaluation quizzes with which the user is less familiar will be improved through repeated practices; where one or more learning rates may be defined by a system default value or by the user.

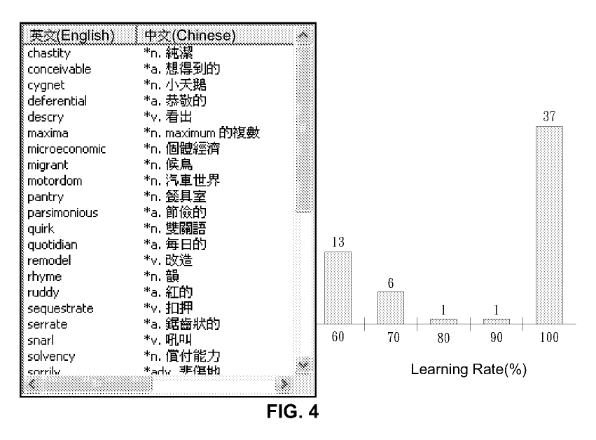

Please refer to FIG. 4, which illustrates a second explanatory diagram of learning rate according to the present invention. When the user “selects” an option a specific learning rate (such as by controlling the cursor to activate an item on a screen of the device to evaluate learning), the evaluation quizzes involved in this learning rate may be shown on the device for evaluating learning. As illustrated in FIG. 4, English Vocabulary Learning is provided as an example of the learning course. When the user selects one of the bars of the learning rate, the related evaluation quizzes involved in the selected bar and/or learning rate (interval), such as vocabulary information (the English/Chinese vocabulary-property list in FIG. 4), will be displayed to the user. Thus by selecting each of the learning rates/bar the user may review the evaluation quizzes involved in the selected learning rate/bar, thereby understanding more about their learning status.

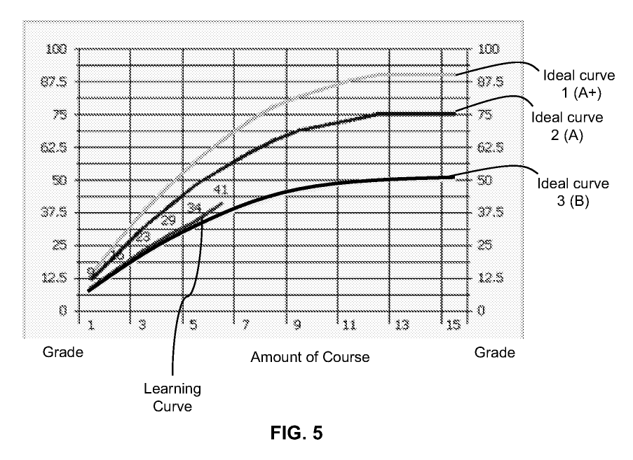

Please refer to FIG. 5, which illustrates an explanatory diagram of the learning curve according to the present invention. The learning information may include learning curve(s) and at least one ideal curve. The user's learning status will be indicated through a comparison of the learning curve and the ideal curve between the learning curve and the ideal curve. As shown in FIG. 5 (though not limited to this disclosure), three ideal curves (ideal curve 1, ideal curve 2 and ideal curve 3) corresponding to three learning statuses (A+), (A) and (B). As the amount of courses increases in the transverse axis, the user's learning curve will change as well. The learning curve will be recalculated very time an evaluation quiz of a new learning course is finished. Thus, as the corresponding evaluation quizzes are completed successively the user will be aware of their current learning status and progress through a comparison of the updated learning curve and the ideal curve between the updated learning curve and the ideal curve(s).

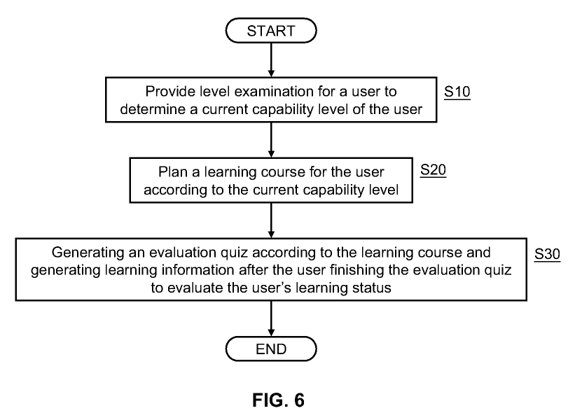

Please refer to FIG. 6, which illustrates an explanatory flow chart of a method for evaluating learning according to a preferred embodiment of the present invention. The method for evaluating learning mainly includes the following steps.

Step S10: Provide a level examination for a user to determine their current capability level; wherein the step of level examination further comprises the following steps. First, store multiple level quizzes corresponding to multiple capability levels respectively. Next, acquire one of the level quizzes according to an initial level to examine the user. The initial level here may be determined by the user.

When the user answers the level quiz “correctly”, increases the level grade and acquire another level quiz higher than the current capability level, to reexamine the user. When the user answers the level quiz “incorrectly”, decrease the level grade and acquire another level quiz lower than the current capability level to reexamine the user. The steps disclosed above will be repeated until the level grade reaches a threshold grade. When the user correctly answers the level quizzes continuously, and the user's accumulated level grade reaches the threshold grade, the user will be recognized at the current capability level.

Step S20: Plan a learning course for the user according to the current capability level; wherein the learning course may include various types of courses to fulfill the needs of different users.

Step S30: Generate an evaluation quiz according to the learning course and generate learning information after the user finishes the evaluation quiz, to evaluate the user's learning status. The evaluation quiz here may be downloaded from an external computer; different evaluation quizzes may be downloaded from the computer even though these evaluation quizzes are downloaded according to the same learning course. After the user finishes the evaluation quiz, generate learning information to evaluate the user's learning status, where the learning information may include examination result(s), learning rate(s) or learning curve(s).

Gather statistics from the evaluation quizzes finished by the user and assign each of the evaluation quizzes to a corresponding learning rate. The corresponding evaluation quiz involved in each of the learning rates will be shown to the user by selecting a learning rate. An evaluation quiz(s) with lower learning rate(s) indicates the user has experienced a less successful learning effect (such as less vocabulary memorized) on the evaluation quiz(s). Therefore, store the evaluation quiz with its learning rate lower than a certain learning rate. During the next course, or whenever the user needs, the stored evaluation quiz(s) may be provided for the user to review, thereby strengthening the memorization effect and enhancing the learning rate corresponding to the stored evaluation quiz.

As to the learning curve, one or more ideal curve(s) may additionally be provided. The user's learning status may be indicated by a comparison of the learning curve and the ideal curve(s). For example, assume there are three ideal curves, which are ideal curve (A+), ideal curve (A) and ideal curve (B). When the learning curve is located in an area upper than the ideal curve (A+), it means the user's learning status is excellent. If the learning curve is located in the area between the ideal curves (A+) and (A), it means the user's learning status is good. When the learning curve is located in an area between the ideal curves (A) and (B), it means the user's learning status is average. If the learning curve is located in an area lower than the ideal curve (B), it means the user's learning status is poor. The learning curve therefore facilitates the user's knowledge of their current learning status.

Additional advantages and modifications will readily occur to those proficient in the relevant fields. The invention in its broader aspects is therefore not limited to the specific details and representative embodiments shown and described herein. Accordingly, various modifications may be made without departing from the spirit or scope of the general inventive concept as defined by the appended claims and their equivalents.

What is claimed is:

1. A device for evaluating learning, comprising:
a level examining module, providing level examination for a user to determine a current capability level of the user;
a course planning module, planning a learning course for the user according to the current capability level determined by the level examining module; and
a course evaluation module, generating an evaluation quiz according to the learning course, and generating learning information after the user finishes the evaluation quiz to evaluate the user's learning status.

2. The device of claim 1, wherein the level examining module comprises:
a level quiz database, storing a plurality of level quizzes corresponding to a plurality of capability levels respectively; and
an analysis unit, acquiring one of the level quizzes from the level quiz database according to an initial level to examine the user.

3. The device of claim 2, wherein the analysis unit increases a level grade and acquires another one of the level quizzes higher than the current one of the capability levels when the user answers the level quiz correctly, and when the user answers the level quiz incorrectly the analysis unit decreases the level grade and acquires another one of the level quizzes lower than the current one of the capability levels to reexamine the user until the level grade reaches a threshold grade.

4. The device of claim 1, wherein the evaluation quiz generated by the course evaluation module is downloaded from a computer and according to the same learning course different evaluation quizzes may be downloaded from the computer.

5. The device of claim 1, wherein the learning information comprises an examination result.

6. The device of claim 1, wherein the learning information comprises a plurality of learning rates, each of the evaluation quizzes finished by the user being gathered as a set of statistics and being assigned to a corresponding one of the learning rates.

7. The device of claim 6, wherein each of the evaluation quizzes involved respectively in each of the learning rates is shown for the user by selecting from the learning rates.

8. The device of claim 6 further comprising a storage module, the storage module storing at least one of the evaluation quizzes if its corresponding learning rate is lower than a certain one of the learning rates.

9. The device of claim 1, wherein the learning information comprises a learning curve and at least one ideal curve, the user's learning status being indicated through a comparison of the learning curve and the ideal curve.

10. A method for evaluating learning comprising the steps of:
providing level examination for a user to determine a current capability level of the user;
planning a learning course for the user according to the current capability level; and
generating an evaluation quiz according to the learning course, and generating learning information after the user finishes the evaluation quiz to evaluate the user's learning status.

11. The method of claim 10, wherein the step of level examination further comprises the steps of:
storing a plurality of level quizzes corresponding to a plurality of capability levels respectively;
acquiring one of the level quizzes according to an initial level to examine the user;
increasing a level grade and acquiring another one of the level quizzes higher than the current one of the capability levels when the user answers the level quiz correctly;
decreasing the level grade and acquiring another one of the level quizzes lower than the current one of the capability levels when the user answers the level quiz incorrectly; and
reexamining the user until the level grade reaches a threshold grade.

12. The method of claim 10, wherein the learning information comprises a plurality of learning rates, each of the evaluation quizzes finished by the user being gathered as a set of statistics and being assigned to a corresponding one of the learning rates.

13. The method of claim 10, wherein the learning information comprises a learning curve and at least one ideal curve, the user's learning status being indicated through a comparison of the learning curve and the ideal curve.
